(19) United States
(12) Patent Application Publication
(10) Pub. No.: US 2006/0282525 A1
(43) Pub. Date: Dec. 14, 2006

(54) Method and apparatus for delegating responses to conditions in computing systems

(76) Inventors: James Ryan Giles, Evansville, IN (US); Reiner Sailer, Scarsdale, NY (US)

Correspondence Address: MOSER, PATTERSON & SHERIDAN LLP;IBM CORPORATION, 595 SHREWSBURY AVE, SUITE 100, SHREWSBURY, NJ, 07702, US

(21) Appl. No.: 11/149,843

(22) Filed: Jun. 10, 2005

(51) Int. Cl. G06F 15/173

(52) U.S. Cl. 709/224

(57) ABSTRACT

One embodiment of the present method and apparatus for delegating responses to conditions in computing systems includes acknowledging (e.g., at a systems management component in the computing system) a condition, and delegating responsibility for a strategy for a response to the condition to another component. In further embodiments, the present method and apparatus for delegating responses to conditions in computing systems includes receiving (e.g., at a computing system component) an assignment from another computing system component (e.g., a systems management component), where the assignment assigns responsibility for a strategy for a response to a condition, and determining whether and how to respond to the condition.

### BACKGROUND

The present invention relates generally to computing systems and relates more particularly to systems management for distributed computing systems.

FIG. 1 is a schematic diagram illustrating a typical distributed computing network or system 100. The system 100 comprises a plurality of components 102₁-102ₙ(e.g., computing devices, hereinafter collectively referred to as “components 102”) grouped into one or more sub-networks or administrative domains 104₁-104ₙ(hereinafter collectively referred to as “domains 104”). At least one of the components 102 (say, component 102₄) is a systems management component.

In systems management, the typical philosophy is one of active management. That is, if the management component 1024 detects a condition that requires a response or resolution (e.g., spam, an Internet Protocol (IP) address collision, a virus or the like originating at another component 102), the management component 102₄ will typically: (a) personally respond to the condition; (b) tell another component 102 exactly how to respond; or (c) log the condition for a human response.

While such an approach is consistent with the operation and design of computing systems that are under a single administrative control (e.g., encompassed in a single domain 104), this approach is less effective where the components 102 are grouped into two or more different domains 104 (and thus are under different administrative control). For example, the management component 102₄ may detect a condition caused by the component 102₂ in domain 104₁, but the domain 104₁, may not be aware that a response is needed. Because the management component 102₄ resides in a different domain than the component 102₂ (e.g., domain 104ₙ), the management component 102₄ may lack the knowledge or authority to directly respond or to issue an effective prescriptive response to another component 102 in the domain 104₁. Thus, the management component 102₄ must typically resort to a coarse-grained response that affects components 102 under its own administrative control, possibly at a cost to other, properly functioning components 102 in the problem domain 104₁, (e.g., turning off the network port of the domain 104₁). Such a coarse-grained response typically requires a great deal of time and human intervention for fine-tuning in both domains 104, and thus can be quite burdensome.

Thus, there is a need in the art for a method and apparatus for delegating responses to conditions in computing systems.

### SUMMARY OF THE INVENTION

One embodiment of the present method and apparatus for delegating responses to conditions in computing systems includes acknowledging (e.g., at a systems management component in the computing system) a condition, and delegating responsibility for a strategy for a response to the condition to another component. In further embodiments, the present method and apparatus for delegating responses to conditions in computing systems includes receiving (e.g., at a computing system component) an assignment from another computing system component (e.g., a systems management component), where the assignment assigns responsibility for a strategy for a response to a condition, and determining whether and how to respond to the condition.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram illustrating a typical distributed computing network or system;

FIG. 2 is a flow diagram illustrating one embodiment of a method for delegating responses to conditions in a computing network, in accordance with the present invention;

FIG. 3 is a flow diagram illustrating one embodiment of a method for resolving a condition detected at a computing network component, in accordance with the present invention; and

FIG. 4 is a high level block diagram of the response delegation method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for delegating responses to conditions in computing systems. Embodiments of the present invention make it possible for a systems management component, when alerted to the existence of a condition in the computing system that requires a response, to delegate the responsibility of the response to another system component. In one embodiment, delegation includes not only delegation of the execution of the response, but also delegation of the determination of the appropriate measures to be taken in the response. Thus, the details of the response are entrusted to a system component that may be better equipped than the systems management component to handle the response (e.g., the delegate component may have more knowledge and/or authority in the domain in which the condition occurs than the systems management component does).

Within the context of the present invention, the term “component” refers to a computing device (e.g., a desktop computer, a laptop computer, a tablet computer, a portable digital assistant, a cellular telephone, a voice-over-IP telephone, a gaming console, a set top box, a server, a router or the like) that is connected to a computing system (e.g., a network or group of connected networks). The term “condition” refers to an undesirable state or action occurring at a component, such as the sending of spam (e.g., unsolicited communications), the sending of viruses, or any other action that interferes with the operation of the computing system (e.g., a denial of service attack).

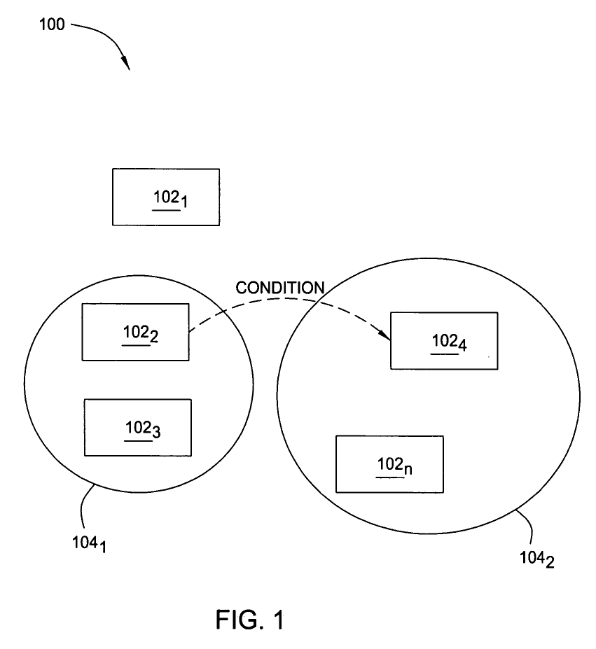

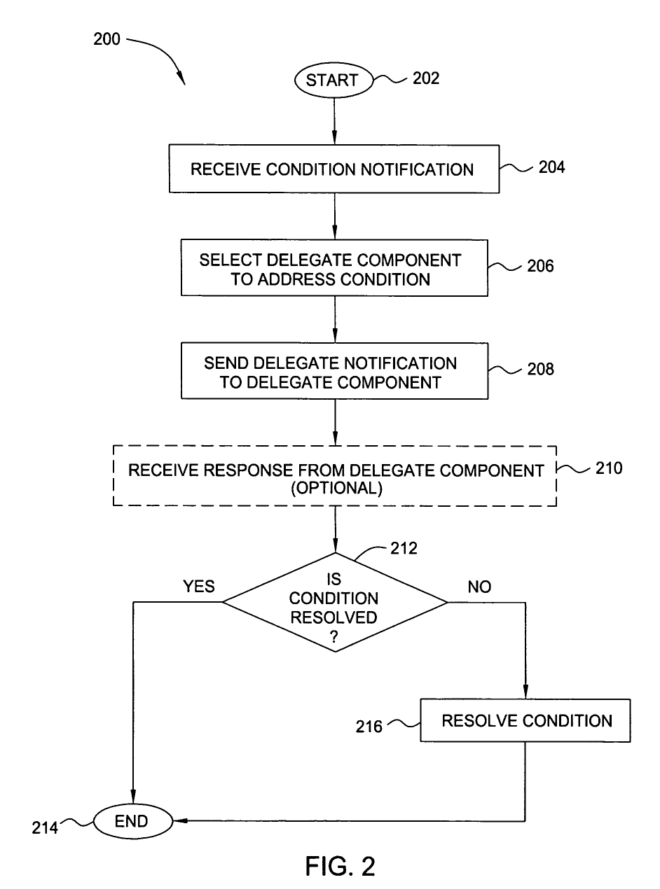

FIG. 2 is a flow diagram illustrating one embodiment of a method 200 for delegating responses to conditions in a computing network, in accordance with the present invention. In one embodiment, the method 200 executes at a component in the computing system that is authorized (e.g., by an administrator of the domain in which the components reside) to delegate responses to other components in the computing network. For example, the method 200 may be executed at an authorized delegating component or systems management component (e.g., systems management component 102₄ of FIG. 1) within the computing system.

The method 200 is initialized at step 202 and proceeds to step 204, where the method 200 receives a condition notification from another component in the computing system. The condition notification indicates a condition, detected at another component in the system, that requires resolution in order to ensure proper functioning of the computing system. In one embodiment, a condition that requires such resolution is at least one of spam (e.g., unsolicited communications) coming from a network component, an IP address collision, a virus residing at or being sent from a network component and an improperly configured or patched component. For example, the condition notification may indicate a denial of service attack coming from a network downstream from the component at which the method 200 is executing. In one embodiment, the condition notification is received directly from the component at which the condition is detected, e.g., via a condition notifier within the component at which the condition is detected. In another embodiment, the condition notification is received from a third component (e.g., via a condition notifier) that has detected a condition at another component.

In step 206, the method 200 selects a delegate component to attempt to resolve the condition indicated in the received condition notification. In one embodiment, the selected delegate component has administrative control over the part of the system causing the condition (e.g., the part of the system in which the component causing the condition resides). For example, the selected delegate component may be a voice-over-IP telephone that serves as a gateway between one or more components causing a denial of service attack and the computing system. In one embodiment, the delegate component is located in a different administrative domain (and is under different administrative control) than the component at which the method 200 is executing (e.g., the delegating component). In another embodiment, the delegate component is located in the same administrative domain as the component at which the method 200 is executing.

The method 200 then proceeds to step 208 and sends a delegate notification to the selected delegate component requesting that the delegate component attempt to resolve the indicated condition. For example, in the case of the detected denial of service attack, the method 200 may send the delegate notification to the voice-over-IP telephone that serves as the network gateway for the component(s) from which the denial of service attack is originating. In one embodiment, the delegate notification does not include a strategy or proposed response to the condition; these details are left to the delegate component's discretion. In further embodiments, the delegate notification includes a description of the nature of the condition.

Once the method 200 sends the delegate notification to the delegate component, the method 200 may optionally wait a predefined period of time until a response is received from the delegate component in step 210 (illustrated in phantom). The received response may indicate, for example, that the delegate component has taken a particular action to resolve the condition (e.g., cutting off all or most outbound network traffic at a network from which a denial of service attack is originating). Alternatively, the received response may indicate that the delegate component was not able to resolve the condition. In further embodiments, the received response may convey supplemental information, such as a deadline at which the condition should be resolved (e.g., so that, if the deadline is accepted by the delegating component, the delegating component can assume, if the deadline expires, that local resolution is not possible and can take appropriate remote action to resolve the condition). This supplemental information might also include, for example, information detected by the delegate component that may aid the delegating component in selecting a more appropriate delegate component (e.g., the delegate component may detect that a third component could be causing the condition and may report this to the delegating component, so that the delegating component can choose to delegate the response to the third component).

In step 212, the method 200 determines whether the condition has been resolved. If the method 200 determines that the condition has been resolved, the method 200 terminates in step 214. Alternatively, if the method 200 detects that the condition has not been resolved (e.g., the condition continues despite response by the delegate component, or the response received in step 210 indicates that the delegate component will not respond), the method 200 proceeds to step 216, resolves the condition, and then terminates in step 214. In one embodiment, resolution of the condition by the method 200, in accordance with step 216, involves a coarse-grained response such as isolation of the domain or portion of the computing system on which the component causing the condition resides (e.g., disabling the port over which the voice-over-IP telephone connects to the computing system). In further embodiments, resolution of the condition in accordance with step 216 involves re-delegating the response to a different delegate component or logging the condition for human intervention. The method 200 may then employ the assistance of an administrator from the domain or portion of the computing system on which the component causing the condition resides in order to fully resolve the condition.

The method 200 thereby enables the efficient resolution of undesirable conditions in a computing system. By delegating all details of the resolution to an appropriate delegate component, rather than personally taking responsibility for the details of every condition that requires response, a systems management component (e.g., a delegating component) can more effectively manage a computing system. The delegate component, which may, for example, have administrative control over the part of the system causing the condition, may have better knowledge of the part of the system causing the condition than the delegating component does. Thus, by delegating to the delegate component, and giving the delegate component the opportunity to provide a surgical response to the condition (e.g., by addressing the condition in any way that the delegate component sees fit), the need for more extreme course-grained responses can be significantly reduced.

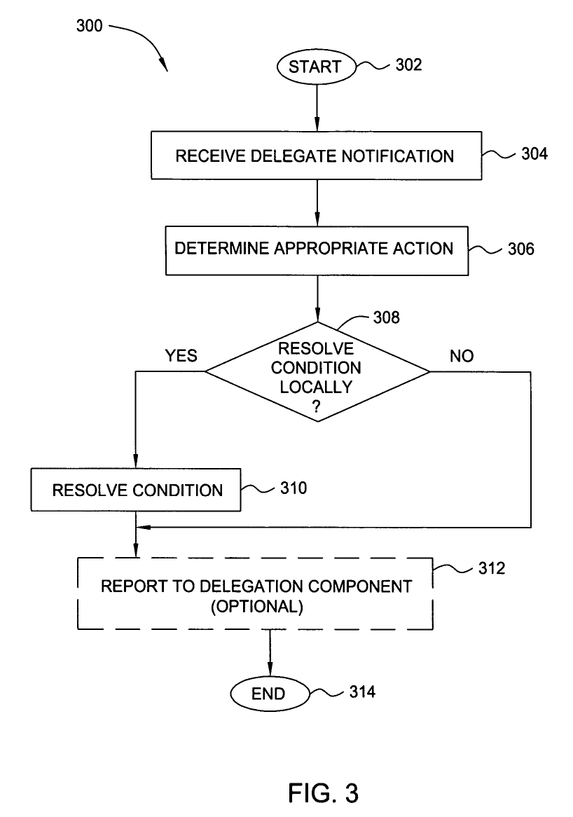

FIG. 3 is a flow diagram illustrating one embodiment of a method 300 for resolving a condition detected at a computing system component, in accordance with the present invention. The method 300 may be executed at, for example, a delegate component within the computing system that has been selected by a delegating component to resolve the condition. In one embodiment, the method 300 executes at a component that resides in the same administrative domain as the component causing the condition.

The method 300 is initialized at step 300 and proceeds to step 302, where the method 300 receives a delegate notification from a delegating component. As described above, the delegate notification notifies the receiving component at which the method 300 is executing that the receiving component has been selected to attempt to resolve a condition at another computing system component. In one embodiment, a servlet that indicates the existence of a condition (but no specific details about the nature of the condition) may be invoked at the component on which the method 300 is executing (e.g., via a web server), prior to the receipt of the delegate notification. In further embodiments, the receipt of the delegate notification may be accompanied by additional information about the associated condition received via a delegation notification server running on a well-known network port of the component on which the method 300 is executing.

In step 306, the method 300 determines the appropriate action or actions to take in order to attempt to resolve the condition in accordance with the condition notification. In one embodiment, the method 300 may determine in accordance with step 306 that it is appropriate to take no action. In one embodiment, the method 300 interacts only with authorized delegating components, so that the appropriate action is determined only if the delegate notification received in step 304 is from an authorized delegating component.

The method 300 then determines, in step 308, whether to resolve the condition locally (e.g., personally). If the method 300 determines that the condition can be resolved locally, the method 300 then proceeds to step 310 and resolves the condition in accordance with the action or actions determined in step 306. For example, in the exemplary case of the denial of service attack, the method 300 may disable system access for the domain or portion of the computing system on which the component(s) causing the denial of service attack resides, so that an administrator in the domain can later address the condition without involving administrators from the domain of the delegating component. In addition, the method 300 may continue to allow the voice-over-IP telephone's own traffic to access the network or may allow another device to connect to a particular component and port on the computing system to retrieve patching software. Alternatively, the method 300 may only isolate or throttle components that are suspected to be responsible for the condition.

The method 300 then optionally reports back to the delegating component in step 312 (illustrated in phantom), to notify the delegating component of the status of the condition (e.g., resolved, unresolved) or of the method 300's intention to take action. Alternatively, if the method 300 determines in step 308 that the condition can not be resolved locally, the method 300 optionally proceeds directly to step 312 and reports to the delegating component. The method 300 then terminates in step 314.

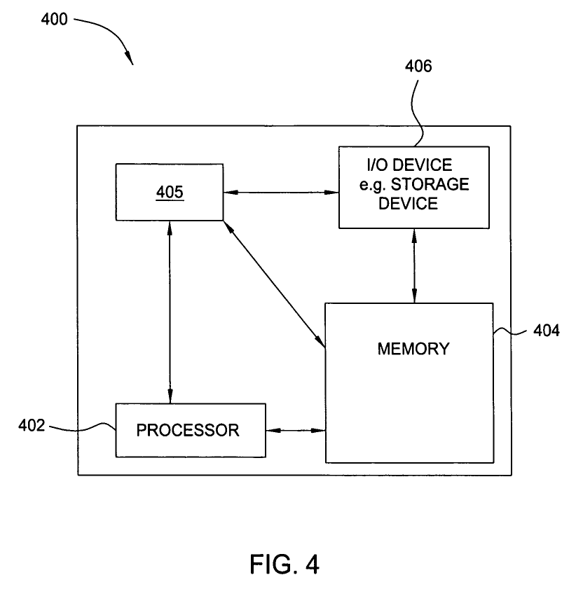

FIG. 4 is a high level block diagram of the response delegation method that is implemented using a general purpose computing device 400. In one embodiment, a general purpose computing device 400 comprises a processor 402, a memory 404, a response delegation module 405 and various input/output (I/O) devices 406 such as a display, a keyboard, a mouse, a modem, and the like. In one embodiment, at least one I/O device is a storage device (e.g., a disk drive, an optical disk drive, a floppy disk drive). It should be understood that the response delegation module 405 can be implemented as a physical device or subsystem that is coupled to a processor through a communication channel.

Alternatively, the response delegation module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the response delegation module 405 for delegating responses to system conditions described herein with reference to the preceding Figures can be stored on a computer readable medium or carrier (e.g., RAM, magnetic or optical drive or diskette, and the like).

Thus, the present invention represents a significant advancement in the field of systems management. A method and apparatus are provided that make it possible for a systems management component, when alerted to the existence of a condition in the computing system that requires a response, to delegate the responsibility of the response (e.g., including the determination of the appropriate measures to be taken in the response) to another system component. Thus, the details of the response are entrusted to a system component that may be better equipped than the systems management component to handle the response (e.g., the delegate component may have more knowledge or authority in the domain in which the condition occurs than the systems management component does). This significantly reduces the amount of time and human intervention that must be devoted to correct the condition, as compared with responses of a more typical, coarse-grained nature.

While foregoing is directed to the preferred embodiment of the present invention, other and further embodiments of the invention may be devised without departing from the basic scope thereof, and the scope thereof is determined by the claims that follow.

1. A method for resolving a condition in a computing system comprising a plurality of components, said method comprising:
acknowledging, by a first component, said condition; and
delegating, by said first component, responsibility for a strategy for a response to said condition to a second component.

2. The method of claim 1, wherein said condition is at least one of: a spam communication, a computer virus, an internet protocol address collision, a denial of service attack, an improperly configured component and an improperly patched component.

3. The method of claim 1, wherein said acknowledging comprises:
receiving, by said first component, a condition notification indicating the existence of said condition.

4. The method of claim 3, wherein said condition notification is received from a component causing said condition.

5. The method of claim 1, wherein said delegating comprises:
selecting said second component from among said plurality of components; and
sending, by said first component, a delegation notification to said second component informing said second component of said selection.

6. The method of claim 5, wherein said delegation notification further comprises a description of a nature of said condition.

7. The method of claim 1, wherein said second component has administrative control over a component causing said condition.

8. The method of claim 1, wherein said first component is authorized to delegate said responsibility.

9. The method of claim 1, further comprising:
receiving, by said first component, a response from said second component, said response indicating a status of said condition.

10. The method of claim 9, wherein said response indicates whether said condition has been resolved by said second component.

11. The method of claim 10, further comprising:
resolving, by said first component, said condition if said response indicates that said second component has not resolved said condition.

12. The method of claim 1, wherein details of said response are left for determination by said second component.

13. A computer readable medium containing an executable program for resolving a condition in a computing system comprising a plurality of components, where the program performs the steps of:
acknowledging, by a first component, said condition; and
delegating, by said first component, responsibility for a strategy for a response to said condition to a second component.

14. The computer readable medium of claim 13, wherein said condition is at least one of: a spam communication, a computer virus, an internet protocol address collision, a denial of service attack, an improperly configured component and an improperly patched component.

15. The computer readable medium of claim 13, wherein said acknowledging comprises:
receiving, by said first component, a condition notification indicating the existence of said condition.

16. The computer readable medium of claim 15, wherein said condition notification is received from a component causing said condition.

17. The computer readable medium of claim 13, wherein said delegating comprises:
selecting said second component from among said plurality of components; and
sending, by said first component, a delegation notification to said second component informing said second component of said selection.

18. The computer readable medium of claim 17, wherein said delegation notification further comprises a description of a nature of said condition.

19. The computer readable medium of claim 13, wherein said second component has administrative control over a component causing said condition.

20. The computer readable medium of claim 13, wherein said first component is authorized to delegate said responsibility.

21. The computer readable medium of claim 13, further comprising:
receiving, by said first component, a response from said second component, said response indicating a status of said condition.

22. The computer readable medium of claim 21, wherein said response indicates whether said condition has been resolved by said second component.

23. The computer readable medium of claim 22, further comprising:
resolving, by said first component, said condition if said response indicates that said second component has not resolved said condition.

24. The computer readable medium of claim 13, wherein details of said response are left for determination by said second component.

25. Apparatus for resolving a condition in a computing system comprising a plurality of components, said apparatus comprising:
means for acknowledging, by a first component, said condition; and
means for delegating, by said first component, responsibility for a strategy for a response to said condition to a second component.

26. A method for resolving a condition in a computing system comprising a plurality of components, the method comprising:
receiving, by a first component, an assignment from a second component delegating responsibility for a strategy for a response to said condition to said first component; and
determining if said first component will respond to said condition.

27. The method of claim 26, wherein said assignment is a delegate notification including a description of a nature of said condition.

28. The method of claim 26, wherein said second component is authorized to delegate said responsibility.

29. The method of claim 26, wherein said determining comprises:
determining an appropriate action to take to resolve said condition; and
resolving said condition in accordance with said appropriate action.

30. The method of claim 26, further comprising:
sending, by said first component, a response to said second component indicating a status of said condition.

31. A computer readable medium containing an executable program for resolving a condition in a computing system comprising a plurality of components, where the program performs the steps of:
receiving, by a first component, an assignment from a second component delegating responsibility for a strategy for a response to said condition to said first component; and
determining if said first component will respond to said condition.

32. The computer readable medium of claim 31, wherein said assignment is a delegate notification including a description of a nature of said condition.

33. The computer readable medium of claim 31, wherein said second component is authorized to delegate said responsibility.

34. The computer readable medium of claim 31, wherein said determining comprises:
determining an appropriate action to take to resolve said condition; and
resolving said condition in accordance with said appropriate action.

35. The computer readable medium of claim 31, further comprising:
sending, by said first component, a response to said second component indicating a status of said condition.
